(19) United States
(12) Patent Application Publication
(10) Pub. No.: US 2014/0138314 A1
(43) Pub. Date: May 22, 2014

(54) FLUORINATED ETHYLENE-PROPYLENE POLYMERIC MEMBRANES FOR GAS SEPARATIONS

(71) Applicant: UOP LLC, Des Plaines, IL (US)

(72) Inventors: Chunqing Liu, Arlington Heights, IL (US); Zara Osman, Glenview, IL (US); Howie Q. Tran, Skokie, IL (US); Changqing Lu, Snyder, NY (US); Andrew J. Poss, Kenmore, NY (US); Rajiv R. Singh, Getzville, NY (US); David Nalewajek, West Seneca, NY (US); Cheryl L. Cantlon, Clarence Center, NY (US)

(73) Assignee: UOP LLC, Des Plaines, IL (US)

(21) Appl. No.: 13/679,251

(22) Filed: Nov. 16, 2012

(51) Int. Cl. B01D 71/34

(52) U.S. Cl. CPC B01D 71/34
USPC 210/650; 96/4; 96/10; 95/45; 95/51; 95/54; 95/47; 95/52; 95/49; 95/53; 210/651; 210/500.42; 210/500.23

(57) ABSTRACT

A fluorinated ethylene-propylene polymeric membrane comprising a copolymer comprising 2,3,3,3-tetrafluoropropene and vinylidene fluoride is disclosed. The fluorinated ethylene-propylene polymeric membranes of the invention are especially useful in gas separation processes in air purification, petrochemical, refinery, and natural gas industries.

### FIELD OF THE INVENTION

This invention relates to a new type of fluorinated ethylene-propylene polymeric membranes with high selectivities for gas separations and more particularly for the use of these membranes in natural gas upgrading.

### BACKGROUND OF THE INVENTION

In the past 30-35 years, the state of the art of polymer membrane-based gas separation processes has evolved rapidly. Membrane-based technologies are a low capital cost solution and provide high energy efficiency compared to conventional separation methods. Membrane gas separation is of special interest to petroleum producers and refiners, chemical companies, and industrial gas suppliers. Several applications of membrane gas separation have achieved commercial success, including N₂ enrichment from air, carbon dioxide removal from natural gas and from enhanced oil recovery, and also in hydrogen removal from nitrogen, methane, and argon in ammonia purge gas streams. For example, UOP's Separex™ cellulose acetate spiral wound polymeric membrane is currently an international market leader for carbon dioxide removal from natural gas.

Polymers provide a range of properties including low cost, permeability, mechanical stability, and ease of processability that are important for gas separation. Glassy polymers (i.e., polymers at temperatures below their T_{g}) have stiffer polymer backbones and therefore allow smaller molecules such as hydrogen and helium pass through more quickly, while larger molecules such as hydrocarbons pass through more slowly as compared to polymers with less stiff backbones. Cellulose acetate (CA) glassy polymer membranes are used extensively in gas separation. Currently, such CA membranes are used for natural gas upgrading, including the removal of carbon dioxide. Although CA membranes have many advantages, they are limited in a number of properties including selectivity, permeability, and in chemical, thermal, and mechanical stability. High performance polymers such as polyimides (PIs), poly(trimethylsilylpropyne), and polytriazole have been developed to improve membrane selectivity, permeability, and thermal stability. These polymeric membrane materials have shown promising intrinsic properties for separation of gas pairs such as CO₂/CH₄, O₂/N₂, H₂/CH₄, and propylene/propane (C₃H₆/C₃H₈).

Commercially available gas separation polymeric membranes, such as CA, polyimide, and polysulfone membranes formed by phase inversion and solvent exchange methods have an asymmetric integrally skinned membrane structure. Such membranes are characterized by a thin, dense, selectively semipermeable surface “skin” and a less dense void-containing (or porous), non-selective support region, with pore sizes ranging from large in the support region to very small proximate to the “skin”. However, it is very complicated and tedious to make such asymmetric integrally skinned membranes having a defect-free skin layer. The presence of nanopores or defects in the skin layer reduces the membrane selectivity. Another type of commercially available gas separation polymer membrane is the thin film composite (or TFC) membrane, comprising a thin selective skin deposited on a porous support. TFC membranes can be formed from CA, polysulfone, polyethersulfone, polyamide, polyimide, polyetherimide, cellulose nitrate, polyurethane, polycarbonate, polystyrene, etc. Fabrication of TFC membranes that are defect-free is also difficult, and requires multiple steps. Yet another approach to reduce or eliminate the nanopores or defects in the skin layer of the asymmetric membranes has been the fabrication of an asymmetric membrane comprising a relatively porous and substantial void-containing selective “parent” membrane such as polysulfone or cellulose acetate that would have high selectivity were it not porous, in which the parent membrane is coated with a material such as a polysiloxane, a silicone rubber, or a UV-curable epoxysilicone in occluding contact with the porous parent membrane, the coating filling surface pores and other imperfections comprising voids. The coating of such coated membranes, however, is subject to swelling by solvents, poor performance durability, low resistance to hydrocarbon contaminants, and low resistance to plasticization by the sorbed penetrant molecules such as CO₂ or C₃H₆.

Many of the deficiencies of these prior art membranes are improved in the present invention which provides a new type of fluorinated ethylene-propylene polymeric membranes with high selectivities for gas separations and more particularly for use in natural gas upgrading.

### SUMMARY OF THE INVENTION

A new type of fluorinated ethylene-propylene polymeric membranes with high selectivities for gas separations has been made.

The present invention generally relates to gas separation membranes and, more particularly, to high selectivity fluorinated ethylene-propylene polymeric membranes for gas separations. The fluorinated ethylene-propylene polymeric membranes with high selectivities described in the current invention were made from copolymers comprising 10-99 mol % 2,3,3,3-tetrafluoropropene-based structural units and 1-90 mol % vinylidene fluoride-based structural units. The present copolymers may contain structural units derived from other monomers such as hexafluoropropene. The present fluorinated ethylene-propylene polymeric membranes have CO₂ permeability at least 5 Barrers (1 Barrer=10¹⁰ cm³ (STP) cm/cm² s (cmHg)) and single-gas CO₂/CH₄ selectivity at least 40 at 35° C. under 791 kPa feed pressure.

The present invention provides a new type of fluorinated ethylene-propylene polymeric membranes with high selectivity for gas separations. One fluorinated ethylene-propylene polymeric membrane described in the present invention is prepared from a copolymer comprising about 90 mol % 2,3,3,3-tetrafluoropropene-based structural units and about 10 mol % vinylidene fluoride-based structural units (abbreviated as PTFP-PVDF-90-10). The present PTFP-PVDF-90-10 copolymer was synthesized from the copolymerization reaction of 2,3,3,3-tetrafluoropropene and vinylidene fluoride. Pure gas permeation testing results showed that this PTFP-PVDF-90-10 polymeric membrane has an intrinsic CO₂ permeability of 7.07 Barrers and single-gas CO₂/CH₄ selectivity of 71.8 at 35° C. under 791 kPa for CO₂/CH₄ separation. This membrane also has intrinsic H₂ permeability of 16.7 Barrers and single-gas H₂/CH₄ selectivity of 176.8 at 35° C. under 791 kPa for H₂/CH₄ separation.

The invention provides a process for separating at least one gas from a mixture of gases using the new fluorinated ethylene-propylene polymeric membranes with high selectivities described herein, the process comprising: (a) providing a fluorinated ethylene-propylene polymeric membrane with high selectivity described in the present invention which is permeable to said at least one gas; (b) contacting the mixture on one side of the fluorinated ethylene-propylene polymeric membrane to cause said at least one gas to permeate the membrane; and (c) removing from the opposite side of the membrane a permeate gas composition comprising a portion of said at least one gas which permeated said membrane.

The new fluorinated ethylene-propylene polymeric membranes with high selectivities are not only suitable for a variety of liquid, gas, and vapor separations such as desalination of water by reverse osmosis, non-aqueous liquid separation such as deep desulfurization of gasoline and diesel fuels, ethanol/water separations, pervaporation dehydration of aqueous/organic mixtures, CO₂/CH₄, CO₂/N₂, H₂/CH₄, O₂/N₂, H₂S/CH₄, olefin/paraffin, iso/normal paraffins separations, and other light gas mixture separations, but also can be used for other applications such as for catalysis and fuel cell applications.

### DETAILED DESCRIPTION OF THE INVENTION

The present invention also provides a copolymer, comprising 2,3,3,3-tetrafluoropropene and vinylidene fluoride that is made into a fluorinated ethylene-propylene polymeric membrane. The copolymer described in the current invention comprises a plurality of first repeating units of formula (I):

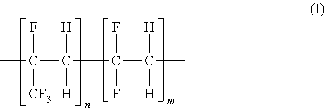

wherein n and m are independent integers from 100 to 20000.

Such copolymers may be prepared by any of the numerous methods known in the art. In a non-limiting example, high molecular weight 2,3,3,3-tetrafluoropropene/vinylidene fluoride copolymers are prepared by aqueous emulsion polymerization, using at least one water soluble radical initiator.

The water soluble radical initiators may include any compounds that provide free radical building blocks for the copolymerization of 2,3,3,3-tetrafluoropropene and vinylidene fluoride monomers. Non-limiting examples of such initiators include Na₂S₂O₈, K₂S₂O₈, (NH₄)₂S₂O₈, Fe₂(S₂O₈)₃, (NH₄)₂S₂O₈/Na₂S₂O₅, (NH₄)₂S₂O₈/FeSO₄, (NH₄)₂S₂O₈/Na₂S₂O₅/FeSO₄, and the like, as well as combinations thereof.

The copolymerization of 2,3,3,3-tetrafluoropropene and vinylidene fluoride monomers may be conducted in any aqueous emulsion solutions, particularly aqueous emulsion solutions that can be used in conjunction with a free radical polymerization reaction. Such aqueous emulsion solutions may include, but are not limited to include, degassed deionized water, buffer compounds (such as, but not limited to, Na₂HPO₄/NaH₂PO₄), and an emulsifier (such as, but not limited to, C₇F₁₅CO₂NH₄, C₄F₉SO₃K, CH₃(CH₂)₁₁OSO₃Na, C₁₂H₂₅C₆H₄SO₃Na, C₉H₁₉C₆H₄O(C₂H₄O)₁₀H, or the like).

The copolymerization is typically carried out at a temperature, pressure and length of time sufficient to produce the desired 2,3,3,3-tetrafluoropropene/vinylidene fluoride copolymers and may be performed in any reactor known for such purposes, such as, but not limited to, an autoclave reactor.

In certain embodiments of the present invention, the copolymerization is carried out at a temperature from about 10° to about 100° C. and at a pressure from about 345 kPa (50 psi) to about 6895 kPa (1000 psi). The copolymerization may be conducted for any length of time that achieves the desired level of copolymerization. In certain embodiments of the present invention, the copolymerization may be conducted for a time that is from about 24 hours to about 200 hours. One of skill in the art will appreciate that such conditions may be modified or varied based upon the desired conversion rate and the desired molecular weight of the resulting 2,3,3,3-tetrafluoropropene/vinylidene fluoride copolymers.

The relative and absolute amounts of 2,3,3,3-tetrafluoropropene monomers and vinylidene fluoride monomers and the amounts of initiator may be provided to control the conversion rate of the copolymer produced and/or the molecular weight range of the copolymer produced as well as to produce membranes with the desired properties. Generally, though not exclusively, the radical initiator is provided at a concentration of less than 1 weight percent based on the weight of all the monomers in the copolymerization reaction.

The initiator may be added into the copolymerization system multiple times to obtain the desired copolymerization yield. Generally, though not exclusively, the initiator is added 1 to 3 times into the copolymerization system.

The following U.S. patents and patent publications further describe the copolymerization of 2,3,3,3-tetrafluoropropene and vinylidene fluoride and are incorporated herein by reference in their entirety: U.S. Pat. No. 2,970,988, U.S. Pat. No. 3,085,996, US 2008/0153977, US 2008/0153978, US 2008/0171844, US 2011/0097529 and WO 2012/125788.

In certain embodiments of the present invention, the copolymer consists essentially of 2,3,3,3-tetrafluoropropene and vinylidene fluoride.

In certain embodiments of the present invention, the ratio of 2,3,3,3-tetrafluoropropene monomer units versus vinylidene fluoride monomer units in the copolymer of the present invention is from about 90:10 mol % to about 10:90 mol %. In certain embodiments of the present invention, the ratio of 2,3,3,3-tetrafluoropropene monomer units versus vinylidene fluoride monomer units in the copolymer of the present invention is from about 90:10 mol % to about 70:30 mol %, from about 70:30 mol % to about 50:50 mol %, from about 50:50 mol % to about 30:70 mol %, and from about 30:70 mol % to about 10:90 mol %.

The fluorinated ethylene-propylene polymeric membranes of the present invention are especially useful in gas separation processes in air purification, petrochemical, refinery, and natural gas industries. Examples of such separations include separation of volatile organic compounds (such as toluene, xylene, and acetone) from an atmospheric gas, such as nitrogen or oxygen and nitrogen recovery from air. Further examples of such separations are for the separation of CO₂ from natural gas, H₂ from N₂, CH₄, and Ar in ammonia purge gas streams, H₂ recovery in refineries, olefin/paraffin separations such as propylene/propane separation, and iso/normal paraffin separations. Any given pair or group of gases that differ in molecular size, for example nitrogen and oxygen, carbon dioxide and methane, hydrogen and methane or carbon monoxide, helium and methane, can be separated using the fluorinated ethylene-propylene polymeric membranes described herein. More than two gases can be removed from a third gas. For example, some of the gas components which can be selectively removed from a raw natural gas using the membranes described herein include carbon dioxide, oxygen, nitrogen, water vapor, hydrogen sulfide, helium, and other trace gases. Some of the gas components that can be selectively retained include hydrocarbon gases.

The following examples further illustrate the invention, but should not be construed to limit the scope of the invention in any way.

### EXAMPLES

### Example 1

### Synthesis of 2,3,3,3-Tetrafluoropropene/Vinylidene Fluoride Copolymer Comprising about 90 Mol % 2,3,3,3-Tetrafluoropropene-Based Structural Units and about 10 Mol % Vinylidene Fluoride-Based Structural Units

### Abbreviated as PTFP-PVDF-90-10

Into 100 mL of degassed deionized water with stirring, 2.112 g of Na₂HPO₄.7H₂O, 0.574 g of NaH₂PO₄, and 2.014 g of C₇F₁₅CO₂NH₄ were added. 0.3068 g of (NH₄)₂S₂O₈ was added into above aqueous solution with stirring and nitrogen bubbling. The obtained aqueous solution was immediately transferred into an evacuated 300 mL autoclave reactor through a syringe. The reactor was cooled with dry ice while the aqueous solution inside was slowly stirred. When the internal temperature decreased to about 0° C., the transfer of a mixture of 2,3,3,3-tetrafluoropropene (111.3 g) and vinylidene fluoride (11.8 g) was started. At the end of the transfer, the internal temperature was below about −5° C. The dry ice cooling was removed. The autoclave reactor was slowly warmed up by air. The aqueous solution inside was stirred at 500 rpm.

When the internal temperature increased to about 15° C., 0.2942 g of Na₂S₂O₅ dissolved in 5 mL degassed deionized water was pumped into the autoclave reactor. The autoclave reactor was slowly heated up to 35° C. The initial internal pressure was 1303 kPa (189 psi).

Over 90 hour polymerization, the stirring became difficult; the temperature drifted to 44° C.; the internal pressure dropped to 1117 kPa (162 psi). The heating and stirring were then stopped. The autoclave reactor was cooled down by air. At room temperature, the residual pressure was slowly released. The white solid polymer precipitate surrounding the stirrer was taken out and crushed into small pieces. The copolymer was thoroughly washed with deionized water and dried under vacuum (74 cm (29 in.) Hg) at 35° C. to dryness. The dry copolymer weighed 71.3 g to give a yield of 57.9%.

The actual monomer unit ratio in the copolymer determined by ¹⁹F NMR was 91.1 mol % of 2,3,3,3-tetrafluoropropene and 8.9 mol % of vinylidene fluoride. The copolymer was soluble in acetone, tetrahydrofuran (THF), and ethyl acetate. The weight average molecular weight of the copolymer measured by gel permeation chromatography (GPC) included 779,780 (major) and 31,832 (minor).

### Example 2

### Synthesis of 2,3,3,3-Tetrafluoropropene/Vinylidene Fluoride Copolymer Comprising about 64 Mol % 2,3,3,3-Tetrafluoropropene-Based Structural Units and about 36 Mol % Vinylidene Fluoride-Based Structural Units

### Abbreviated as PTFP-PVDF-64-36

Into 100 mL of degassed deionized water with stirring, 2.112 g of Na₂HPO₄.7H₂O, 0.574 g of NaH₂PO₄, and 2.014 g of C₇F₁₅CO₂NH₄ were added. 0.3018 g of (NH₄)₂S₂O₈ was added into above aqueous solution with stirring and nitrogen bubbling. The obtained aqueous solution was immediately transferred into an evacuated 300 mL autoclave reactor through a syringe. The autoclave reactor was cooled with dry ice and the aqueous solution inside was slowly stirred. When the internal temperature decreased to about 0° C., the transfer of a mixture containing 77.1 g of 2,3,3,3-tetrafluoropropene and 32.3 g of vinylidene fluoride into the autoclave reactor was started. At the end of the transfer, the internal temperature was below about −5° C. The dry ice cooling was removed. The autoclave reactor was slowly warmed up by air. The aqueous solution inside was stirred at 300 rpm.

0.2905 g of Na₂S₂O₅ dissolved in 10 mL degassed deionized water was pumped into the autoclave reactor. The autoclave reactor was slowly heated up to 35° C. A slight exothermic initiation process was observed. The stir rate was increased to 500 rpm. The initial internal pressure was 2261 kPa (328 psi).

After 38 hours, the internal pressure dropped to 379 kPa (55 psi). The heating was then stopped. The autoclave reactor was cooled down by air. The stir rate was decreased to 50 rpm. At room temperature, the residual pressure was slowly released. The white solid polymer chunk was taken out and crushed into small pieces. The copolymer was thoroughly washed with deionized water and dried under vacuum (74 cm (29 in.) Hg) at 35° C. to dryness. The dry copolymer weighed 98.3 g to give a yield of 89.9%.

The actual monomer unit ratio in the copolymer determined by ¹⁹F NMR was 63.8 mol % of 2,3,3,3-tetrafluoropropene and 36.2 mol % of vinylidene fluoride. The copolymer was slowly soluble in acetone, THF, and ethyl acetate. The weight average molecular weight of the copolymer measured by GPC was 452,680.

### Example 3

### Synthesis of 2,3,3,3-Tetrafluoropropene/Vinylidene Fluoride Copolymer Comprising about 22 Mol % 2,3,3,3-Tetrafluoropropene-Based Structural Units and about 78 Mol % Vinylidene Fluoride-Based Structural Units

### Abbreviated as PTFP-PVDF-22-78

Into 100 mL of degassed deionized water with stirring, 2.153 g of Na₂HPO₄.7H₂O, 0.568 g of NaH₂PO₄, and 2.048 g of C₇F₁₅CO₂NH₄ were added. 0.2598 g of (NH₄)₂S₂O₈ was added into above aqueous solution with stirring and nitrogen bubbling. The obtained aqueous solution was immediately transferred into an evacuated 300 mL autoclave reactor through a syringe. The autoclave reactor was cooled with dry ice and the aqueous solution inside was slowly stirred at 50 rpm. When the internal temperature decreased to about −4° C., a mixture containing 47.7 g of 2,3,3,3-tetrafluoropropene and 45.8 g of vinylidene fluoride was transferred into the autoclave reactor. The dry ice cooling was removed. The autoclave reactor was slowly warmed up by air. The aqueous solution inside was stirred at 300 rpm.

When the internal temperature increased to about 0° C., 0.2986 g of Na₂S₂O₅ dissolved in 5 mL degassed deionized water was pumped into the autoclave reactor. The stir rate was increased to 500 rpm. The autoclave reactor was slowly warmed up to room temperature. When the autoclave reactor was slowly heated up to 30° C., an exothermic initiation process was observed. The internal temperature increased to about 38° C. The internal pressure was 4199 kPa (609 psi) at this time.

Occasionally, the autoclave reactor was cooled with dry ice to control the internal temperature between 34° and 36° C.

After 1 hour, the heating was started to maintain the internal temperature at 35° C. After a total of 15 hours, the internal pressure dropped to 427 kPa (62 psi) at 35° C. The heating was then stopped. The autoclave reactor was cooled down by air. The stir rate was decreased to 50 rpm. At room temperature, the residual pressure was slowly released. The white solid copolymer precipitate was thoroughly washed with deionized water and dried under vacuum (74 cm (29 in.) Hg) at 35° C. to dryness. The dry copolymer weighed 84.6 g to give a yield of 90.4%.

The actual monomer unit ratio in the copolymer determined by ¹⁹F NMR was 22.1 mol % of 2,3,3,3-tetrafluoropropene and 77.9 mol % of vinylidene fluoride. The copolymer was soluble in dimethylformamide (DMF), and slowly soluble in acetone, THF, and ethyl acetate. The weight average molecular weight of the copolymer measured by GPC was 534,940.

### Example 4

### Synthesis of 2,3,3,3-Tetrafluoropropene/Vinylidene Fluoride Copolymer Comprising about 30 Mol % 2,3,3,3-Tetrafluoropropene-Based Structural Units and about 70 Mol % Vinylidene Fluoride-Based Structural Units

### Abbreviated as PTFP-PVDF-30-70

Into 100 mL of degassed deionized water with stirring, 2.146 g of Na₂HPO₄.7H₂O, 0.578 g of NaH₂PO₄, and 2.022 g of C₇F₁₅CO₂NH₄ were added. 0.1552 g of (NH₄)₂S₂O₈ was added into the above aqueous solution with stirring and nitrogen bubbling. The obtained aqueous solution was immediately transferred into an evacuated 300 mL autoclave reactor through a syringe. The autoclave reactor was cooled with dry ice and the aqueous solution inside was slowly stirred. When the internal temperature decreased to about −2° C., the transfer of a mixture of 2,3,3,3-tetrafluoropropene (27.7 g) and vinylidene fluoride (80.1 g) into the autoclave reactor was started. At the end of the transfer, the internal temperature was below about −5° C. The dry ice cooling was removed. The autoclave reactor was slowly warmed up by air. The aqueous solution inside was stirred at 300 rpm.

When the internal temperature increased to about 3° C., 0.1609 g of Na₂S₂O₅ dissolved in 5 mL degassed deionized water was pumped into the autoclave reactor. The autoclave reactor was slowly heated towards 35° C.; meanwhile, the stir rate was increased to 500 rpm. A vigorous exothermic initiation process was observed at about 26° C. The autoclave reactor was periodically cooled with dry ice to maintain the temperature between 26° and 30° C.

After 2 hours, the periodic dry ice cooling was stopped. The internal temperature was about 31° C. The stir rate was decreased to 300 rpm. The corresponding internal pressure was 3792 kPa (550 psi). After overnight polymerization at room temperature, the internal temperature of polymerization mixture dropped to 24° C.

The autoclave reactor was then cooled with dry ice. When the internal temperature decreased to about 2° C., 0.1044 g of (NH₄)₂S₂O₈ dissolved in 5 mL of degassed deionized water was pumped into the autoclave reactor, followed by 10 mL of degassed deionized water to rinse the pumping system. 0.1189 g of Na₂S₂O₅ dissolved in 5 mL of degassed deionized water was pumped into the autoclave reactor, followed by 10 mL of degassed deionized water to rinse the pumping system.

The dry ice cooling was removed. The autoclave reactor was warmed up by air. Meanwhile, the stir rate was increased to 500 rpm. The autoclave reactor was then slowly heated to 35° C. The corresponding internal pressure was 3827 kPa (555 psi) at this time.

After a total of 35 hours of polymerization, the internal pressure decreased to 3627 kPa (526 psi). The heating was stopped. The stir rate was decreased to 50 rpm. At room temperature, the residual pressure was slowly released. The copolymer precipitate was taken out and thoroughly washed with deionized water. The copolymer was dried under vacuum (74 cm (29 in.) Hg) at 35° C. to dryness. The dry copolymer weighed 84.9 g to give a yield of 78.7%.

The actual monomer unit ratio in the copolymer determined by ¹⁹F NMR was 29.3 mol % of 2,3,3,3-tetrafluoropropene and 70.7 mol % of vinylidene fluoride. The copolymer is soluble in DMF, and partially soluble in acetone and THF. The copolymer is not soluble in ethyl acetate. The copolymer physically shows the characteristic of an elastomer at room temperature. The weight average molecular weight of the copolymer measured by GPC was 635,720.

### Example 5

### Preparation of PTFP-PVDF-90-10 Polymeric Membrane

### Abbreviated as PTFP-PVDF-90-10-M

A PTFP-PVDF-90-10 polymeric dense film membrane was prepared as follows: 5.0 g of PTFP-PVDF-90-10 polymer comprising about 90 mol % 2,3,3,3-tetrafluoropropene-based structural units and about 10 mol % vinylidene fluoride-based structural units was dissolved in 20 g of acetone. The mixture was stirred for 2 hours to form a homogeneous casting dope. The resulting homogeneous casting dope was filtered and allowed to degas overnight. The PTFP-PVDF-90-10-M polymeric dense film membrane was prepared from the bubble free casting dope on a clean glass plate using a doctor knife with a 35-mil gap. The membrane together with the glass plate was dried at room temperature for 12 hours and was then dried at 40° C. under vacuum for at least 48 hours to completely remove the residual acetone solvent to form a PTFP-PVDF-90-10-M polymeric dense film membrane.

### Example 6

### Evaluation of the CO₂/CH₄ and H₂/CH₄ Separation Performance of PTFP-PVDF-90-10-M Membrane Prepared in Example 5

The PTFP-PVDF-90-10-M membrane in dense film form was tested for CO₂/CH₄ and H₂/CH₄ separations at 35° C. under 791 kPa (100 psig) pure gas feed pressure. The results in Tables 1 and 2 show that the new PTFP-PVDF-90-10-M membrane has intrinsic CO₂ permeability of 7.07 Barrers (1 Barrer=10⁻¹⁰ cm³ (STP) cm/cm² s (cmHg)) and single-gas CO₂/CH₄ selectivity of 71.8 at 35° C. under 791 kPa for CO₂/CH₄ separation. This membrane also has intrinsic H₂ permeability of 16.7 Barrers and single-gas H₂/CH₄ selectivity of 176.8 at 35° C. under 791 kPa for H₂/CH₄ separation.

TABLE 1
Pure gas permeation test results of PTFP-PVDF-90-
10-M dense film membrane for CO₂/CH₄ separation ^{a}

| Dense film | P_{CO2} (Barrer) | α_{CO2/CH4} |
|---|---|---|
| PTFP-PVDF-90-10-M | 7.07 | 71.8 |

^{a} Tested at 35° C. under 791 kPa (100 psig) pure gas pressure; 1 Barrer = 10⁻¹⁰ (cm³(STP) · cm)/(cm² · sec · cmHg)

TABLE 2
Pure gas permeation test results of PTFP-PVDF-90-
10-M dense film membrane for H₂/CH₄ separation ^{a}

| Dense film | P_{H2} (Barrer) | α_{H2/CH4} |
|---|---|---|
| PTFP-PVDF-90-10-M | 16.7 | 176.8 |

^{a} Tested at 35° C. under 791 kPa (100 psig) pure gas pressure; 1 Barrer = 10⁻¹⁰ (cm³(STP) · cm)/(cm² · sec · cmHg)

### Example 7

### Preparation of PTFP-PVDF-90-10 Thin Film Composite (TFC) Membrane

### Abbreviated as PTFP-PVDF-90-10-TFC

A 5 wt % solution of PTFP-PVDF-90-10 copolymer was made by dissolving 2.5 g of PTFP-PVDF-90-10 copolymer in 47.5 g of acetone and stirring on a stir plate for 2 hours. The resulting homogeneous solution was filtered and allowed to degas. The outside surface of a 0.1 μm pore size stainless steel membrane support from Mott Corporation was wrapped with Teflon tape. The inside surface of this membrane support was coated with 5 wt % PTFP-PVDF-90-10 copolymer solution by dipping the membrane support tube vertically in the solution for 30 seconds. The tube was then carefully removed from the solution and left to dry in a hood at room temperature for 1 hour. The Teflon tape was removed from the tube and the tube was left to dry in a hood at room temperature for another 3 hours. The coated tube was then dried in a vacuum oven set at 40° C. overnight to form PTFP-PVDF-90-10-TFC membrane.

1. A fluorinated ethylene-propylene polymeric membrane comprising a copolymer comprising 10-99 mol % 2,3,3,3-tetrafluoropropene-based structural units and 1-90 mol % vinylidene fluoride-based structural units.

2. The membrane of claim 1 further comprising structural units derived from other monomers.

3. The membrane of claim 2 wherein said other monomers comprise hexafluoropropene.

4. The membrane of claim 1 wherein said membrane has a CO₂ permeability of at least 5 Barrers and a single-gas CO₂/CH₄ selectivity of at least 40 at 35° C. under 791 kPa feed pressure.

5. The membrane of claim 1 wherein said membrane is prepared from a copolymer comprising 85-95 mol % 2,3,3,3-tetrafluoropropene-based structural units and 5-15 mol % vinylidene fluoride-based structural units.

6. The membrane of claim 1 wherein said membrane is prepared from a copolymer comprising 70-90 mol % 2,3,3,3-tetrafluoropropene-based structural units and 10-30 mol % vinylidene fluoride-based structural units.

7. The membrane of claim 1 wherein said membrane is prepared from a copolymer comprising 50-70 mol % 2,3,3,3-tetrafluoropropene-based structural units and 30-50 mol % vinylidene fluoride-based structural units.

8. The membrane of claim 1 wherein said membrane is prepared from a copolymer comprising 30-50 mol % 2,3,3,3-tetrafluoropropene-based structural units and 50-70 mol % vinylidene fluoride-based structural units.

9. The membrane of claim 1 wherein said membrane is prepared from a copolymer comprising 10-30 mol % 2,3,3,3-tetrafluoropropene-based structural units and 70-90 mol % vinylidene fluoride-based structural units.

10. The membrane of claim 1 wherein the copolymer consists essentially of 2,3,3,3-tetrafluoropropene and vinylidene fluoride.

11. The membrane of claim 1 wherein said membrane is fabricated into a sheet, tube or hollow fibers.

12. A process of separating at least two gases or two liquids comprising contacting said gases or liquids with a membrane comprising a copolymer comprising 10-99 mol % 2,3,3,3-tetrafluoropropene-based structural units and 1-90 mol % vinylidene fluoride-based structural units

13. The process of claim 12 wherein said membrane comprises a copolymer comprising 70-90 mol % 2,3,3,3-tetrafluoropropene-based structural units and 10-30 mol % vinylidene fluoride-based structural units.

14. The process of claim 12 wherein said gases are separated from natural gas and comprise one or more gases selected from the group consisting of carbon dioxide, oxygen, nitrogen, water vapor, hydrogen sulfide and helium.

15. The process of claim 12 wherein said gases are volatile organic compounds.

16. The process of claim 15 wherein said volatile organic compounds are selected from the group consisting of toluene, xylene and acetone.

17. The process of claim 12 wherein said gases comprise a mixture of carbon dioxide and at least one gas selected from hydrogen, flue gas and natural gas.

18. The process of claim 12 wherein said gases are a mixture of olefins and paraffins or iso and normal paraffins.

19. The process of claim 12 wherein said gases comprise a mixture of gases selected from the group consisting of nitrogen and oxygen, carbon dioxide and methane, hydrogen and methane or carbon monoxide, helium and methane.
